(19) United States
(12) Patent Application Publication
(10) Pub. No.: US 2007/0143191 A1
(43) Pub. Date: Jun. 21, 2007

(54) Multimedia book and method

(75) Inventor: Michael Santasiero, Paramus, NJ (US)

Correspondence Address: Allan W. Watts;Bryan Cave, LLP, Suite 2200, Two North Central Avenue, Phoenix, AZ, 85004-4406, US

(73) Assignee: Sterling Publishing, Co., Inc.

(21) Appl. No.: 11/317,091

(22) Filed: Dec. 21, 2005

(51) Int. Cl. G06Q 30/00

(52) U.S. Cl. 705/26

(57) ABSTRACT

Multimedia systems and articles for teaching or conveying information, and methods of selling information. Embodiments include a cover, pages attached to the cover, and machine-readable storage media located within a case attached to the cover that includes a tray and a hinged lid. The cover and pages may be browsable before purchase when in a retail establishment, but the case may be sealed until after purchase. The information may be on arts or crafts, such as instructions for making artwork or craftwork. Substantially identical articles or similar articles on different subjects may be displayed for sale and sold in the retail establishment. The storage media may include CDs DVDs, or both, and may contain static and audiovisual information. The case may be configured to hold both a CD and a DVD on a common spindle.

### FIELD OF THE INVENTION

This invention relates generally to books, packaging for machine-readable data storage media, articles, and systems for conveying information and teaching, combinations thereof, and methods of providing and selling information and of improving such devices.

### BACKGROUND OF THE INVENTION

In the past, information has been conveyed through books, and more recently through machine-readable storage media including compact discs (CDs) and digital video discs (DVDs). CDs have been used to store audio recordings, such as music, and also to store software and information that is displayable on a multipurpose computer, such as a personal computer (PC), among other things. Information that has been stored on various media has included static (still) information such as text, still photographs, and drawings, as examples. DVDs have been used to store audio (sound) and video (motion pictures), collectively “audiovisual” information, which has been displayed using a screen such as a television and a DVD player, for example. Information has been conveyed that teaches people various subjects, including teaching people how to make things. Information has been conveyed that teaches people how to engage in or make arts and crafts as examples. For instance, books have been sold in retail establishments for this purpose.

U.S. Patent Application, publication No. 2004/0188283, application Ser. No. 10/814,455, (Andersen) concerns books, namely, children's books, that hold a CD in the cover. The cover slides open to provide access to the CD. In addition, U.S. Pat. No. 6,068,117 (Koehn) concerns a book insert CD carrier and notes marketing of a book and CDs as a unit. Furthermore, U.S. Pat. No. 5,617,950 concerns a CD container shaped like a book, and U.S. Patent Application publication No. 2005/0040058, application Ser. No. 10/644,985 (Touzani) concerns a device for storing DVDs.

However, various areas for improvement over the known art exist. Specifically, there are needs and room for improvement in areas that include systems, articles, and methods of presenting and selling information on particular subjects that include both pages containing written text and machine-readable storage media. For instance, there are needs and room for improvement in presenting and selling articles and systems containing information in a manner such that the pages are browsable before purchase. In addition, there are needs and room for improvement in the packaging of multimedia information such that systems or articles conveying the information can be stored and displayed on a book shelf like a book.

Furthermore, there are needs and room for improvement in the manner in which discs containing machine-readable information are stored or packaged, such that the discs are protected and yet are easily accessible. Still further, there are needs and room for improvement in devices for storing discs such as CDs and DVDs such that multiple discs can readily be stored. Even further, there are specific needs and room for improvement in systems and articles of manufacture that contain information teaching how to make something, information related to arts or crafts, and information teaching how to make particular types of artwork or craftwork, for example. Further still, there are needs and room for improvement in systems and methods of preventing various of the media in a multimedia system from becoming separated from the system or article before being sold to a purchaser.

There are also needs and room for improvement in such systems, articles, and methods to make them inexpensive, easy to use, resistant to damage, and reliable, among other things. Other needs and room for improvement may be apparent to a person of skill in the art having studied this document.

### SUMMARY OF PARTICULAR EMBODIMENTS OF THE INVENTION

An invention that in various embodiments satisfies one or more of those needs, provides one or more improvements over the art, and provides still other benefits has now been developed.

In various embodiments, this invention provides, as examples, multimedia systems for teaching people to make certain things, articles of manufacture for conveying information, and various methods, including methods of selling information. The information may be on at least one particular subject, for example, a subject related to arts or crafts. For instance, in some embodiments the subject may involve instructions for making particular varieties of artwork or craftwork. In many embodiments, a plurality of substantially identical articles of manufacture are provided or obtained, which may be displayed for sale and sold in a retail establishment, for instance. In a number of embodiments there are a plurality of similar articles of manufacture having different subjects. These different subjects may relate to different areas of arts and crafts, for instance. The similar articles may have covers with various similarities, such as substantially the same dimensions, for example.

Certain embodiments of the invention include a cover having at least a front and a back, and each cover may have dimensions including a height and a width. In some embodiments, the cover further includes a rectangular spine, and the front of the cover may be hingedly attached to the front edge of the spine, for example. The back of the cover may be similarly hingedly attached to the back edge of the spine, and the spine may be substantially perpendicular to both the front of the cover and the back of the cover when the cover is closed, for instance. In many of these embodiments, there may be indicia or writing, such as a label or title, on the spine identifying the subject. This indicia may be visible when the cover is closed and the article is placed on a book shelf like a book, for example.

In a number of embodiments, a plurality of pages containing written text on the subject are located between the front and the back of the cover (e.g., when the cover is closed), and in some embodiments, the pages may be attached to the cover. Many embodiments further include at least one machine-readable storage medium containing information on the subject and located within a case between the front and the back of the cover when the cover is closed. In a number of embodiments, this case is also attached to the cover. In some embodiments, the case includes a tray and a lid, and the lid may be hingedly attached to the tray. In certain embodiments, the cover and pages are browsable before purchase when in the retail establishment, for example, but the case containing the storage media is sealed, and the seal is configured to be broken by the purchaser after purchase of the article.

The storage medium or media may include, for example, audio, video, both (audiovisual information), still information such as digitally encoded text, or a combination thereof. In some embodiments, each type of information may include information on the subject of the particular system or article. In some embodiments, the storage media include one or more discs, such as a CD, a DVD, or both. The CD may contain still information such as text on the subject that may be displayable, printable, or both, with a multi-purpose computer or computer system, and the DVD may contain audiovisual information on the subject, and may be configured to be played on a standard DVD player, for example. In some embodiments, the CD contains printable information comprising a parts list, a pattern, or both. In certain embodiments, the storage media may contain information on how to make artwork or craftwork, for instance. In some embodiments, the case may have a spindle, and the case may be configured to hold both a CD and a DVD on the same common spindle.

Various objects, advantages, and benefits exist for many of the different embodiments of the invention described herein. Such objects, advantages, and benefits may include at least partially satisfying one or more of the various needs or room for improvement over the art. Other objects, advantages, and benefits will be apparent to a person of ordinary skill in the art or will be found herein. Not all of the embodiments necessarily address all or any of the needs or objects or provide the advantages or benefits specifically described herein.

### BRIEF DESCRIPTION OF THE DRAWINGS

To facilitate further description of the invention, the following drawings are provided in which:

FIG. 1 is an isometric view of an example of an article or system for conveying information in accordance with the invention showing the front of the article or system with the cover closed;

FIG. 2 is an isometric view of the article or system of FIG. 1 showing the back of the article or system, also with the cover closed;

FIG. 3 is an isometric view of the article or system of FIGS. 1 and 2 shown with the cover open;

FIG. 4 is an isometric view of the article or system of FIGS. 1, 2, and 3 shown with the cover open and the pages separated;

FIG. 5 is an isometric view of the article or system of the previous FIGS. shown with the cover open and the lid of the case partially open;

FIG. 6 is a partially exploded isometric view of the article or system of the previous FIGS. shown with the cover open, the lid of the case open, and illustrating how two discs mount on a common spindle;

FIG. 7 is a partial isometric view of the article or system of the previous FIGS. shown with the cover open, the lid of the case open, and including section A-A through the spindle and through attachment points between the tray and the cover; and

FIG. 8 is a flow chart illustrating an example of a method of distributing articles in accordance with the invention.

These drawings are provided for illustrative purposes only and should not be used to unduly limit the scope of the invention.

### DETAILED DESCRIPTION OF EXAMPLES OF EMBODIMENTS

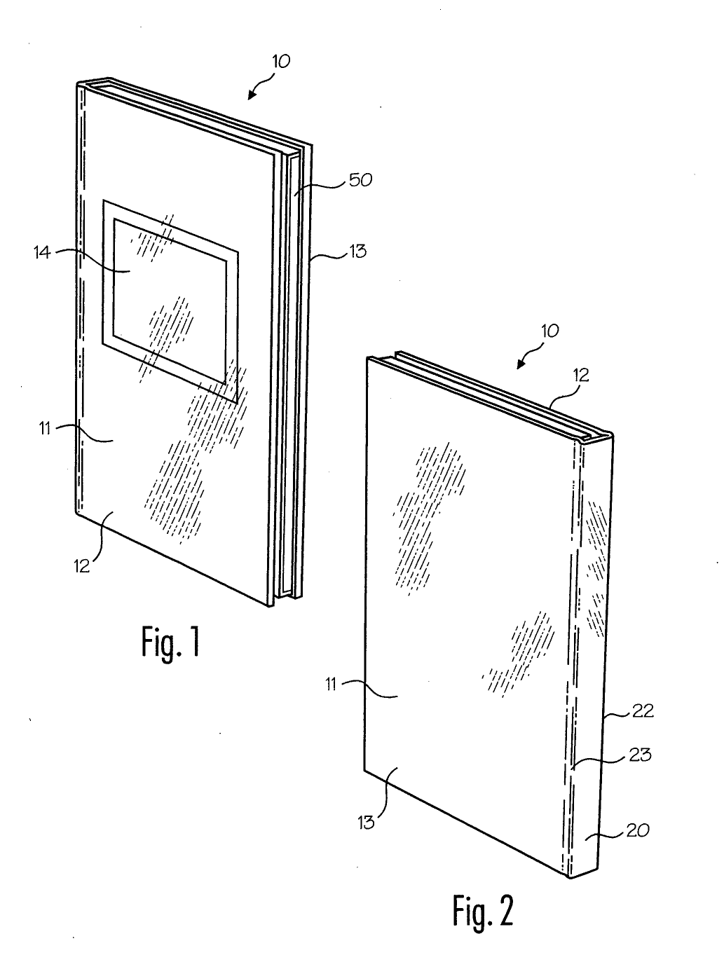

FIGS. 1-7 illustrate an example of an article or system 10 for conveying information in accordance with the invention. This embodiment may be, for example, a multimedia system for teaching people to make things, or an article of manufacture for conveying information on at least one subject.

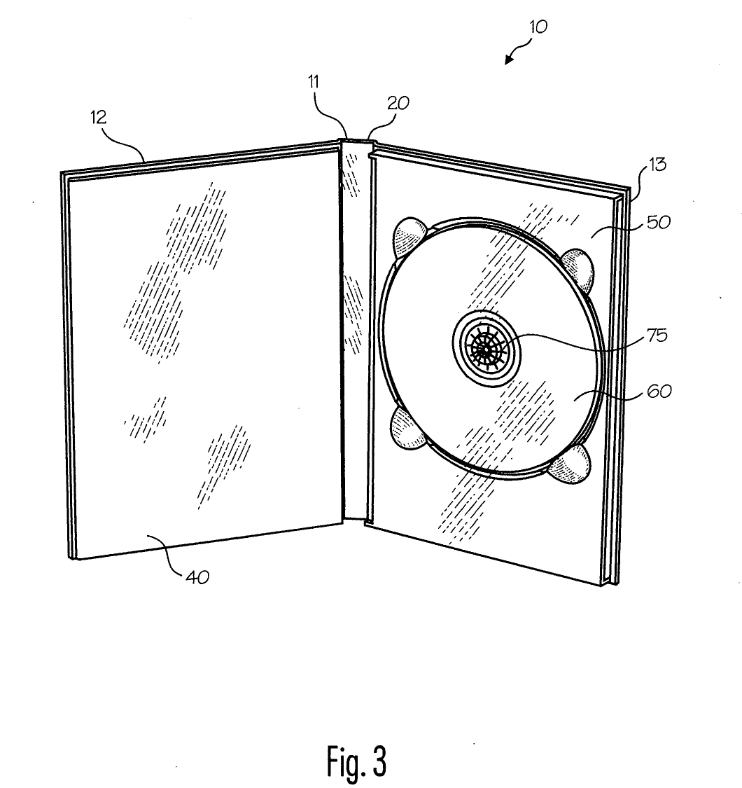

Article or system 10 includes a cover 11 that has a front 12 (having an outer major face and an inner major face) and a back 13 (having an outer major face and an inner major face). Cover 11 is shown closed in FIGS. 1 and 2 and open in FIGS. 3-7. In FIG. 1, the outer major face of front 12 is prominent, and in FIG. 2, the outer major face of back 13 is prominent. Cover 11, and specifically front 12 and back 13, each have dimensions such as a height, a width, and a thickness. In this embodiment, the height and width of front 12 and back 13 are substantially the same. As used herein, “dimensions that are substantially the same” are the same to within typical manufacturing tolerances for articles such as books. Dimensions that are substantially the same may be within one (1) percent of each other, or 1/16 inch, for example. In certain embodiments, cover 11 (front 12 and back 13) has a height of about 7½ inches and a width of about 5 9/16 inches, for example. In certain embodiments, when closed, article 10 has a thickness of about ¾ inches.

In the embodiment illustrated, cover 11 further includes a rectangular spine 20 having a front edge 22 and a back edge 23, shown in FIG. 2, for example. In this embodiment, the front 12 of cover 11 is hingedly attached to front edge 22, and back 13 of cover 11 is similarly hingedly attached to back edge 23. As used herein, “hingedly” means like a hinge, for example, allowing rotation about a line, or about two points that form a line, like a hard cover of a book, for instance. In many embodiments, this line may occupy the same plane as spine 20 and front 12 or back 13, for example. In the embodiment illustrated, spine 20 may be substantially perpendicular to both the front 12 of cover 11 and to the back 13 of cover 11 when cover 11 is closed, for instance, as shown in FIGS. 1 and 2. Cover 11 may be made of materials that are used to make covers for hard back books, such as cardboard, for example.

In many embodiments, there are indicia (e.g., writing or a label) on spine 20. Such indicia may identify the subject, include a title of the article or system 10, or both, for example. If it had been included in the drawings, such indicia would be visible in FIG. 2 for example. This indicia may be visible when cover 11 is closed and article 10 is placed on a book shelf like a book, for instance.

In many embodiments, indicia (e.g., writing or a label) may be found on front 12 of cover 11, such as in location 14 shown in FIG. 1. This indicia may include the title of the article, the subject that the article is about, the author, one or more trademarks, or the like, for example. Benefits of this embodiment include that article 10 may be stored on a book shelf like a book, potentially with books (e.g., upright or stacked, so that their respective covers are abutting one another), and article 10 may be identifiable, or the subject or title of article 10 may be determinable, from viewing spine 20. Article 10 may be stored and displayed in this manner in a retail establishment or the home of a purchaser, for instance.

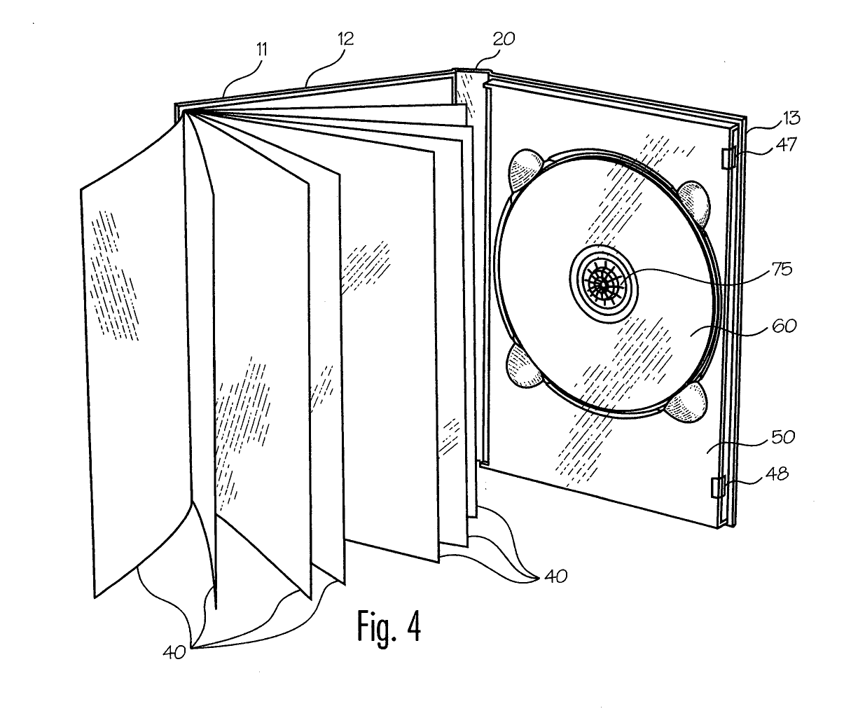

In the embodiment illustrated, article 10 includes a pamphlet or a plurality of pages 40, shown best in FIG. 4. FIG. 4 shows pages 40 separated, while FIG. 3 shows pages 40 all contacting each other, such as they might be when cover 11 is first opened or is still closed (as in FIGS. 1 and 2). FIG. 4 shows eight or nine pages 40, but other embodiments may have a different number of pages 40. Pages 40 may contain written text on the subject of the article or system 10, for example. In some embodiments, pages 40 may include pictures, drawings, lists (e.g., a list of materials needed for a project), contents, patterns, tables, a glossary, or the like. In some embodiments, pages 40 may be in color.

Pages 40 are located between the front 12 and the back 13 of cover 11 when cover 11 is closed, for example, as shown in FIGS. 1 and 2. In some embodiments, pages 40 may be attached to cover 11, for example, with adhesive. In some embodiments, pages 40 may be attached to cover 40 in a manner that allows pages 40 to be separated from cover 11 and reattached. An example of this is through a hook and loop fastener such as VELCRO fasteners or via a reattachable adhesive. Such an attachment method may be referred to herein as being “semi-permanently attached.” As used herein, “permanently attached” means that pages 40 and cover 11 cannot be separated without damaging either pages 40 or cover 11. Further, as used herein, “attached” encompasses both permanently and semi-permanently attached.

As shown in FIGS. 3 and 4, in this embodiment, pages 40 are attached to the inner major face of front 12 of cover 11. In other embodiments, pages 40 may be attached to another part of cover 11, such as back 13 or spine 20. In addition, in the embodiment illustrated, pages 40 are attached to, and join each other at, the side (near the long edge) of front 12 opposite to (away from) spine 20. In other embodiments, pages 40 may be attached to, and join each other at, the side of front 12 (or of back 13) that is adjacent to spine 20 or, less preferably, at the top or bottom of either cover.

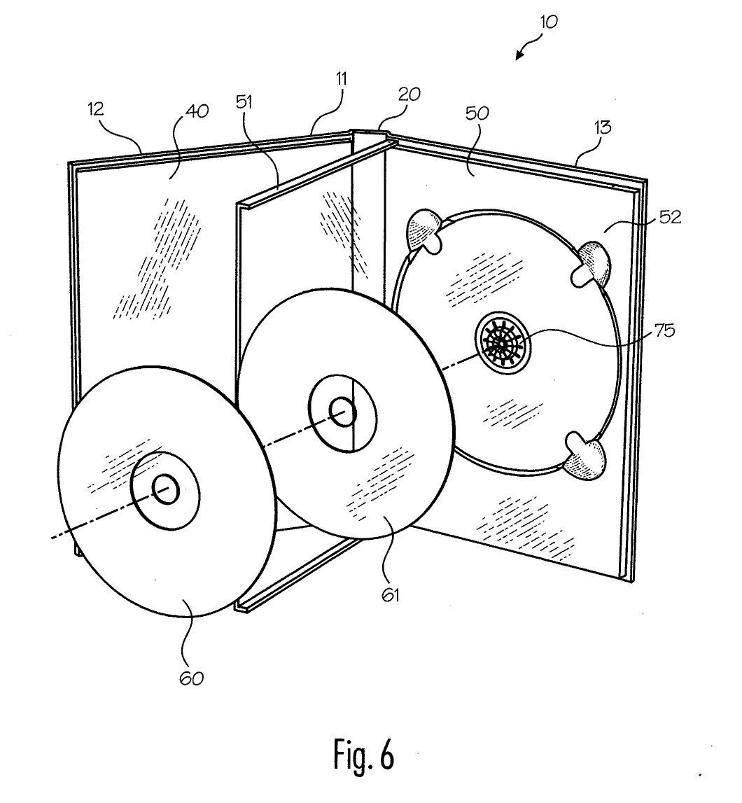

Many embodiments of the invention further include at least one machine-readable storage medium containing information on the subject of the system or article. In the embodiment illustrated, article 10 includes discs 60 and 61, shown best in FIG. 6. In this embodiment, discs 60 and 61 are located or stored within case 50, shown in FIGS. 3-5, for example. As shown in FIG. 1, in this embodiment, case 50 is located between the front 12 and the back 13 of cover 11 when cover 11 is closed. In this embodiment, case 50 is attached to the cover 11, specifically, to the inner major face of back 13 of cover 11. Case 50 may have overall dimensions that are less than the overall dimensions of cover 11. For example, in some embodiments, case 50 may have a height of about 7¼ or 7⅜ inches, a width of 5¼, 5⅜, or 5½ inches, and a thickness or depth of ¼, 5/16, or ⅜ inch.

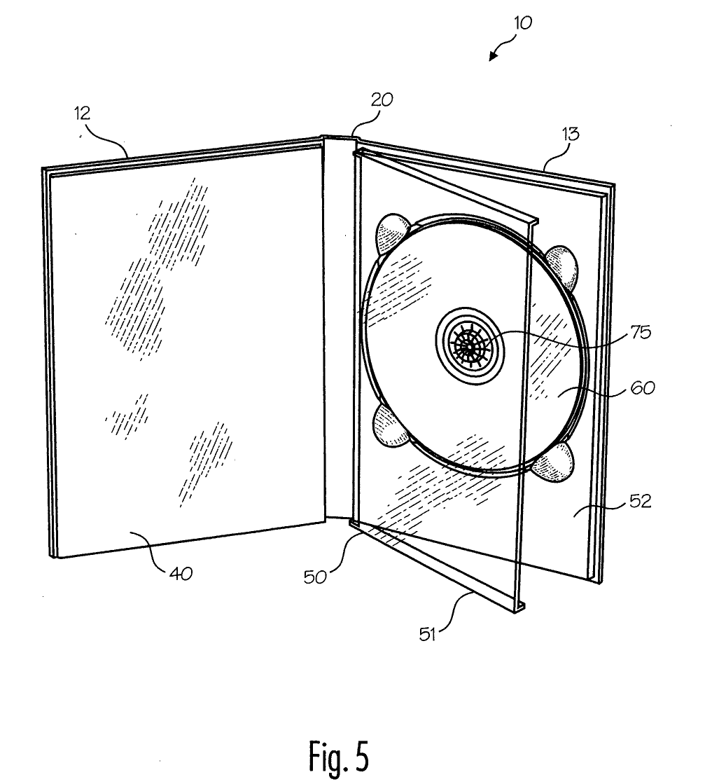

In addition, in this embodiment, case 50 includes a tray 52 and a lid 51, and lid 51 is hingedly attached to tray 52 at or near their respective long edges that are closest to spine 20 (attachment at or near the other long edge or at or near either of the two shorter edges is also possible but not preferred). Lid 51 is shown closed in FIG. 3 and FIG. 4, slightly open in FIG. 5, and further open in FIG. 6. In some embodiments, lid 51 can open a full 180 degrees from tray 52 (i.e., the major plane of lid 51 can be parallel to the major plane of tray 52 and in some cases can be co-planar), which may prevent damage to case 50, for example, if an object is placed on article 10 when lid 51 is open. In this embodiment, lid 51 is also closed when cover 11 is fully closed, in FIGS. 1 and 2, for example. Further, in this embodiment, lid 51 is pushed closed when cover 11 is closed by a user, which may also help to avoid damage to case 50, as well as saving the step of separately closing lid 51.

In a particular embodiment, lid 51 has a height of 7.39 inches, a width of 5.29 inches, and a material thickness of 0.035 inches, and a flange thickness of 0.047 inches. In that particular embodiment, pins formed on the top and bottom flanges of lid 51 have a diameter of 0.091 inches and a height of 0.071 inches. These pins fit into holes in the flanges of tray 52 to allow lid 51 to pivot. In other words, these pins and holes hingedly attach lid 51 to tray 52. In that same embodiment, tray 52 has a height of 7.28 inches, a width of 5.29 inches, a general material thickness of 0.035 inches, and a flange thickness of 0.051 inches. In this embodiment, tray 52 is 0.252 inches deep (thick).

In the embodiment illustrated, tray 52 and lid 51 provide a safe place to store discs 60 and 61 that protects the discs. In this embodiment, tray 52 and lid 51 are made of a transparent plastic, and at least disc 60 is visible inside case 50 when cover 11 is open even when lid 51 is closed. The ability to see through lid 51 is illustrated in FIGS. 3, 4, and 5, for example. In other embodiments, lid 51, tray 52, or both, may be made of another material, which may be translucent or opaque, for example, and may have a window through which to see disc 60 or both discs 60 and 61. In some embodiments, writing, artwork, or illustrations may be provided on tray 52, lid 51, or both, and/or on cover 11, which may include the part of the inner major face of back 13 that is visible through lid 51, tray 52, or both. Further, in some embodiments, writing, a title, the subject, artwork, illustrations, or the like may be provided on discs 60, 61, or both.

Storage media, such as discs 60 and 61, may contain digital information, which may include, for example, audio, video, both audio and video (audiovisual information), still information such as digitally encoded text, pictures, figures, or a combination thereof. In some embodiments, each type of information may include information on the subject of article 10, for example. In the embodiment illustrated, the storage media includes the two discs 60 and 61, which may be compact discs (CDs) digital video discs (DVDs), or one of each, for example. In this embodiment, a CD may contain still information such as text on the subject that may be displayable, printable, searchable, alterable, or a combination thereof, with a multi-purpose computer or computer system, for example. In some embodiments, a CD contains printable information comprising a parts list, a pattern, or both, for instance.

Further, a DVD may contain audiovisual information on the subject, and may be configured to be played on a standard DVD player, for example. In some embodiments, the audiovisual information may be divided into chapters, on different topics for example. In certain embodiments, the article or system 10 may be interactive. In some embodiments, a user may be able to find a particular topic in a table of contents on pages 40 and then go directly to that chapter on a DVD, skipping previous chapters, for example, through a graphical user interface or menu system. In some embodiments, a table of contents may be found at the beginning of the DVD instead or in addition to the table of contents on pages 40.

In some other embodiments, such information may be provided on other types of machine-readable storage media, on just one disc, on three or more discs, on other types of machine-readable storage media, or the like.

In the embodiment shown, case 50, and specifically tray 52, includes a spindle 75, which includes a plurality of fingers that hold discs 60 and 61 in place. Thus, case 50 is configured to hold both discs 60 and 61, for example, both a CD and a DVD, on the same common spindle 75. Spindle 75 may be longer than known designs configured to hold a single disc, but may be similar in other ways. Spindle 75 may hold discs 60 and 61 with a snap fit, for example. In particular embodiments spindle 75 may have a diameter of 0.587 to 0.606 inches, for example, where spindle 75 contacts discs 60 and 61.

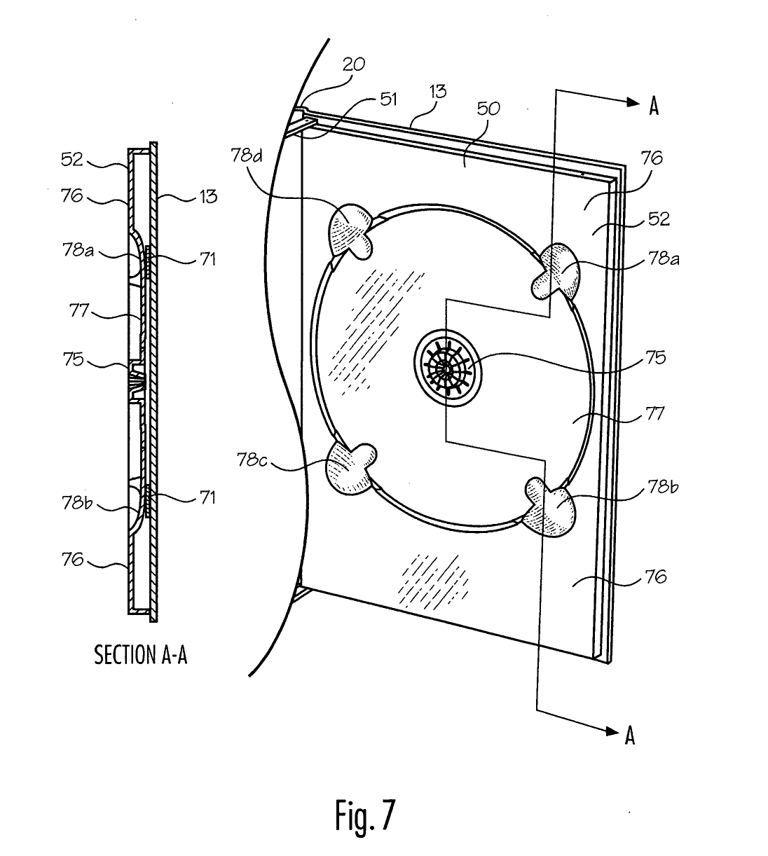

Referring to FIG. 7, in the embodiment illustrated, tray 52 includes well 77 configured to hold discs 60 and 61. In this embodiment, tray 52 also includes surrounding raised section (land) 76. Tray 52 also includes indentations 78a, 78b, 78c, and 78d in this embodiment. A user may insert a finger into one or more of these indentations to remove disc 60, disc 61, or both from well 77. In the embodiment illustrated, tray 52 is attached to cover 11 with adhesive 71 applied to the back of indentations 78a, 78b, 78c, and 78d. In some embodiments, well 77 may be deeper than known wells to facilitate holding two or more discs, for example, discs 60 and 61.

Lid 51 may be hingedly attached to tray 52 with projections (ears) that fit into indentations in tray 52. Each projection may, for example, have an integral pin that fits into a hole in the respective indentation along the narrow top edge or bottom edge of tray 52 near spine 20, the two pins being co-axial and defining the axis of rotation of lid 51. In other embodiments locations of these projections and indentations may be reversed. Lid 51 may be held closed over tray 52 with an interference or snap fit, for example. Such a fit may involve detents or projections that fit into indentations, for instance.

In certain embodiments, cover 11 and pages 40 are browsable before purchase when in a retail establishment, for example. In other words, a shopper can open cover 11 and pages 40 before purchase to learn about article 10 to determine whether to purchase article 10. But in some embodiments, case 11, containing the storage media, specifically discs 60 and 61 in this embodiment, is sealed, for example, with tape 47 and 48 shown in FIG. 4. In other embodiments, another type of seal may be used, such as shrink wrap or at least one sticker, instead of or in addition to tape 47 and 48. The seal may be configured to be broken by the purchaser after purchase of article 10.

In this embodiment, a potential purchaser can see disc 60, and probably the edges of disc 61, since lid 51 is transparent. But tape 47 and 48 reduce the likelihood that discs 60 and 61 will become separated from article 10 in the retail establishment before purchase. In addition to being desired by the merchant, tape 47 and 48 assures a potential purchaser that they are purchasing the discs 60 and 61 that were intended to be included with article 10. After purchase, tape 47 and 48 may be torn, cut, or removed entirely by the user.

In certain embodiments, article 10 may contain information for teaching one or more people on a particular subject. Thus, article or system 10 may be instructional in many embodiments. In some embodiments article 10 may teach how to make something. In some embodiments, article 10 may relate to arts, crafts, or creative projects, or may be hobby-related, for example. In particular embodiments, article 10 may teach a user how to make artwork or craftwork, for instance. Examples of such artwork or craftwork include scrapbooking, crocheting, beading, beaded crocheting, and paper crafts (papercrafts) for example. Other examples include, throwing pottery, soap making, quilt making, knitting, sewing, embroidery, macramé, stenciling, painting, sculpting, leatherwork, rock polishing, bola tie making, jewelry making, wood working, metal working, glass blowing, model building, interior decorating, remodeling, animal (e.g., dog) training, care, and grooming, and horticulture.

Information on the subject may be included on pages 40, as well as on one or more machine-readable storage media, such as discs 60 and 61. Thus, in some embodiments, electronic and paper teaching tools are combined into one article or system 10. Video or audiovisual information, for example, on a DVD, may contain tutorials, or instructing examples, for instance. Still information, such as a CD ROM, may contain printable patterns, decorating ideas, parts lists (which may be printable), artwork, frames, strips, etc.

In many embodiments, the different storage media may cross-reference each other. For instance, a DVD may indicate where to look on a CD for particular information. As another example, pages 40 may include a table of contents for machine-readable storage media, such as a DVD, a CD, or the like. In some embodiments, a DVD may contain video providing general information, one or more examples, or both, while a CD may provide more detailed information, specifics on particular topics, additional examples, or a combination thereof. In some embodiments, storage media, such as digitally encoded text, may contain links or hyperlinks to other locations, to audio or video, to websites on the Internet, or the like. In some embodiments, a graphical user interface may provide links to various information within the storage media, on the Internet, or the like.

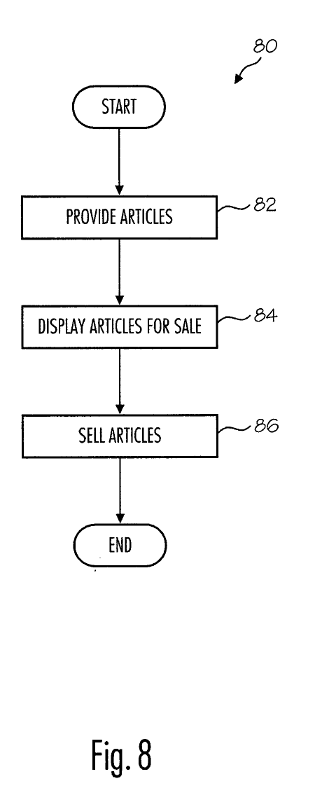

In addition to systems and articles, such as system or article 10, the invention includes various methods, including methods of distributing or selling information and methods of making or improving system or article 10. FIG. 8 illustrates an example of a method 80 of distributing or selling information. This information may be on at least one particular subject, such as the subjects described herein, for example. In the embodiment illustrated, method 80 includes the step of providing or obtaining articles (step 82), which may be similar to article 10, for example. In some embodiments, a plurality of substantially identical articles of manufacture may be provided or obtained, for example. These articles may have substantially the same dimensions for instance, substantially the same content, be on the same subject, or a combination thereof. As used herein, “substantially identical articles” have substantially the same width, height, and thickness (within manufacturing tolerances, for instance), be on the same subject, and have at least 99 percent of the same content.

The articles that are provided or obtained (in step 82, for example) may have any number of the features described herein for article 10. For example, articles may have a cover, pages with written text on the subject, which may be attached to the cover and may be located between the front and the back of the cover (e.g., when the cover is closed). In some embodiments, the articles may each include at least one machine-readable storage medium containing information on the subject, which may contain digital data. In many embodiments, the medium may be located within a case between the front and the back of the cover (when the cover is closed), or the case may be attached to the cover, or both.

In the embodiment illustrated, method 80 also includes the step of displaying the articles for sale (step 84). The articles may be displayed for sale in a retail establishment, for example. Articles may be displayed for sale (step 84) in stores, such as department stores or book stores, for instance. In many embodiments, the cover and pages are browsable before purchase when in the retail establishment. Further, in some embodiments, the case containing the storage medium may be sealed in the retail establishment and the seal may be configured to be broken by the purchaser only after purchase of the article.

In this embodiment, method 80 further includes the step of selling the articles (step 86). In various embodiments, displaying the articles (step 84) in the manner described allows a potential purchaser to open the cover and look at the pages (i.e., so that the pages are browsable) and that may help to provide the information that the potential purchaser needs or wants in order to decide whether or not to purchase the article (e.g., in step 86). Further, in many embodiments, because the storage media or discs are visible, and yet are sealed within the case, potential purchasers may have more confidence that the correct storage media are within the article and are in good condition, which may lead to more sales (e.g., in step 86).

The information may be on at least one particular subject, for example, a subject related to arts or crafts. For instance, the subject may involve instructions for making particular varieties of artwork or craftwork. In many embodiments, a plurality of substantially identical articles of manufacture are provided, which may be displayed for sale in at least one retail establishment, for instance. In a number of embodiments there are a plurality of similar articles of manufacture that may have different subjects. These different subjects may all relate to arts and crafts, for instance. The similar articles may have covers with substantially the same dimensions, for example.

Thus, in some embodiments, the steps of method 80 may be repeated for a plurality of similar articles of manufacture having different subjects. The similar articles may have covers with substantially the same dimensions, for example. In some embodiments, the covers may have substantially the same width and height, for instance. In some such embodiments the different subjects may be related to teaching, arts, crafts, creative projects, or making different types of things, such as artwork or craftwork, for example. The similar articles may have similar decorating schemes, similar cases, similarly arranged pages, similar fonts, similar cover arrangements, common trademarks, and the like.

As used herein, “similar articles of manufacture” have at least one of the following in common: the same height and width; at least one common trademark that suggests a common aspect of all of the various subjects; and similar decorative schemes (e.g., trade dress). Further, as used herein, “substantially similar articles of manufacture” have all of the following in common: substantially the same height and width; at least one common trademark that suggests a common aspect of all of the various subjects; and similar decorative schemes (e.g., trade dress). Still further, as used herein, “similar decorative schemes” have at least one of the following in common: the same font and font sizes; the same pattern regardless of color; the same color regardless of pattern; and the same distinctive printed geometric shape or shapes.

In some embodiments, the similar articles of manufacture may have trademarks that include or suggest art, crafts, creating, creative projects, or the like. An example of a common trademark is “CREATE WITH THE DESIGNERS™” which may be printed on the top of the outer major surface of front 12 of cover 11, for example of article 10. Another example is “CREATE WITH ME”. In some embodiments, the similar articles of manufacture may have trademarks that include or suggest that the articles are interactive or contain multiple media, or the like. An example of a common trademark is “AN INTERACTIVE DVD BOOK™” which may be printed on the bottom of the outer major face of front 12 of cover 11, for example. In some embodiments, similar articles of manufacture may have different color schemes, different titles, different pictures or illustrations, for example on the spine, so that an owner or potential purchaser can tell them apart without difficulty, even if they are placed together on a book shelf in a home or in a store. In some embodiments, similar articles of manufacture may address the same subject but may be by different authors and have different content.

The invention has been described in an illustrative manner and, except as otherwise noted, the terminology that has been used is intended to be in the nature of description rather than of limitation. Modifications and variations that can be made should be apparent in light of the teachings herein. It is, therefore, to be understood that within the scope of the claims, the invention can be practiced otherwise than as specifically described and that the claims are intended to cover all modifications and variations falling within the true spirit and scope of the invention.

What is claimed is:

1. A method of selling information on at least one subject to a purchaser, the method comprising in the following order at least the steps of:
obtaining a plurality of substantially identical articles of manufacture, each article comprising:
a cover having at least a front and a back, each cover having dimensions including at least a height and a width,
a plurality of pages containing written text on the subject and located between the front and the back, wherein the pages are attached to the cover, and
at least one machine-readable digital storage medium containing information on the subject and located within a case between the front and the back, wherein the case is attached to the cover;
displaying the articles for sale in a retail establishment wherein the cover and pages are browsable before purchase when in the retail establishment and the case containing the storage medium is sealed in the retail establishment and the seal is configured to be broken by the purchaser after purchase of the article; and
selling at least a plurality of the articles at the retail establishment.

2. The method of claim 1, the cover further comprising a rectangular spine having a front edge and a back edge wherein the front of the cover is hingedly attached to the front edge and the back of the cover is hingedly attached to the back edge, and wherein the spine is substantially perpendicular to the front of the cover and to the back of the cover when the cover is closed, and wherein the spine includes indicia identifying the subject wherein the indicia are visible when the cover is closed and placed on a book shelf like a book.

3. The method of claim 1 wherein the steps are repeated for a plurality of similar articles of manufacturer having different subjects, the similar articles at least having covers with substantially the same dimensions.

4. The method of claim 1 wherein the case includes a tray and a lid, wherein the lid is hingedly attached to the tray.

5. The method of claim 1 wherein the at least one digital storage medium includes audio, video, and digitally encoded text, each of the audio, video, and text comprising information on the subject.

6. The method of claim 1, the at least one digital storage medium comprising a CD and a DVD, the CD comprising text on the subject displayable and printable with a multi-purpose computer system, and the DVD comprising audiovisual information on the subject.

7. The method of claim 1 wherein the subject consists essentially of how to make at least one of an art and a craft.

8. An article of manufacture configured for conveying information on at least one subject, the article comprising:
a cover having at least a front and a back;
a plurality of pages containing written text on the subject and located between the front and the back;
a CD containing information on the subject that is displayable on a multipurpose computer;
a DVD containing audiovisual information on the subject and configured to be played on a standard DVD player; and
a case located between the front and the back, wherein the case is attached to the cover, comprises a hinged lid, and a spindle, and wherein the case is configured to hold both the CD and the DVD on the spindle.

9. The article of manufacture of claim 8, the cover further comprising a rectangular spine having a front edge and a back edge wherein the front of the cover is hingedly attached to the front edge and the back of the cover is hingedly attached to the back edge, and wherein the spine is substantially perpendicular to the front of the cover and to the back of the cover when the cover is closed, and wherein the spine includes indicia identifying the subject wherein the indicia are visible when the cover is closed and placed on a book shelf like a book.

10. The article of manufacture of claim 8 wherein the subject consists essentially of how to make at least one of an art and a craft.

11. The article of manufacture of claim 10 wherein the CD contains printable information comprising at least one of a parts list and a pattern.

12. The article of manufacture of claim 8 wherein the pages are attached to the cover.

13. The article of manufacture of claim 8 wherein the case includes a seal configured to prevent the case from being opened before the article is purchased, and wherein the pages are browsable before purchase.

14. A multimedia system for teaching people to make artwork or craftwork, the system comprising:
a cover having at least a front and a back wherein the cover is configured to contain the system;
a plurality of pages containing written text located between the front and the back, wherein the pages are attached to the cover; and
at least one machine-readable storage medium containing information on how to make the artwork or craftwork, wherein the storage medium is located within a case located between the front and the back, wherein the case is attached to the cover; and
wherein the storage medium includes audiovisual information on how to make the artwork or craftwork and the storage medium includes static information that is displayable on a multipurpose computer.

15. The system of claim 14 wherein at least one of the pages and the static information includes at least one pattern for making the artwork or craftwork.

16. The system of claim 14 wherein at least one of the pages and the static information includes at least one parts list for materials for making the artwork or craftwork.

17. The system of claim 14 wherein the cover and pages are configured to be browsable before purchase when being offered for sale in a retail establishment and the case containing the storage medium is sealed until after purchase by a customer.

18. The system of claim 14, the cover further comprising a rectangular spine having a front edge and a back edge wherein the front of the cover is hingedly attached to the front edge and the back of the cover is hingedly attached to the back edge, and wherein the spine is substantially perpendicular to the front of the cover and to the back of the cover when the cover is closed, and wherein the spine includes indicia identifying the subject wherein the indicia are visible when the cover is closed and placed on a book shelf like a book.

19. The system of claim 14 wherein the case includes a tray and a lid, wherein the lid is hingedly attached to the tray.

20. The system of claim 19 wherein the case is attached to the cover.

21. The system of claim 14, the storage medium comprising a CD and a DVD.

22. The system of claim 14 wherein the storage medium includes audio, video, and digitally encoded text, each of the audio, video, and text comprising information on the artwork or craftwork.
